(19) United States
(12) Patent Application Publication
(10) Pub. No.: US 2016/0174579 A1
(43) Pub. Date: Jun. 23, 2016

(54) High Fiber Cheesecake Product with Extensive Shelf Life

(71) Applicant: General Mills, Inc., Minneapolis, MN (US)

(72) Inventors: Jeffrey J. Resch, Minneapolis, MN (US); Laura Zimmerer, Minneapolis, MN (US)

(73) Assignee: GENERAL MILLS, INC., Minneapolia, MN (US)

(21) Appl. No.: 14/575,538

(22) Filed: Dec. 18, 2014

(51) Int. Cl. A21D 13/00; A21D 13/08

(52) U.S. Cl. CPC A21D 13/0025; A21D 13/08; A21D 13/0041

(57) ABSTRACT

A food bar includes a base or crust, along with a cheesecake filling provided on the base. The cheesecake filling is non-flowable and is made with real cream cheese but without the use of preservatives. The cheesecake filling has a water activity of less than 0.6, enabling the filling to exhibit an extensive shelf life without refrigeration.

### BACKGROUND OF THE INVENTION

The invention generally pertains to the art of food and, more particularly, to a cheesecake food product having an extensive shelf life and, preferably, also a significant fiber content, as well as a method of making the food product. In accordance with one aspect of the invention, a cheesecake snack bar, including a crust or base and a high fiber cheesecake filling, is provided, with the cheesecake snack bar having a shelf life of approximately eight months without refrigeration or preservatives. In accordance with another aspect of the invention, the cheesecake snack bar represents an excellent source of fiber, while retaining textural and sensory properties of an indulgent cheesecake.

Lifestyle choices have resulted in many people relying on snack products to satisfy breakfast, between meal and even dessert needs. For instance, pastries are common snack products which fulfill some of these needs. Typically, pastries are intended to be consumed within a few days from when they are made, mainly due to the inclusion of filling materials which have short shelf lives. In the case of certain pastries including a filling material, such as a cheesecake filling, the filling material may be directly exposed. In addition, pies and cakes exhibit similar characteristics, at least in the sense that generally employed ingredients equate to short shelf lives.

To satisfy market demand, a wide range of filling-based snack products have been developed and made available for sale. If designed for sale without refrigeration, a general shelf life could be in the order of thirty (30) days. With product advancements, these shelf lives have been achieved for snack products containing a wide range of fillings, including fruit fillings and even cheesecake fillings. Even though this shelf life would likely be deemed adequate for a wide range of product uses, it would be advantageous to provide for cheesecake filling-based snack products which are formulated from real cream cheese, yet have even further extended shelf lives. Although counterintuitive given that the use of real cream cheese would seemingly equate to the need for refrigeration and exhibit a short shelf life, it would be even further advantageous to provide a cheesecake filling containing snack product having a long, stable shelf life, particularly without the need for preservatives. Even further advantageous would be a cheesecake snack product having a significant fiber content.

### SUMMARY OF THE INVENTION

In accordance with one aspect of the invention, a cheesecake filling is specifically configured to exhibit an extensive, stable shelf life, i.e., a shelf life of approximately eight (8) months, without refrigeration. The extensive shelf life is achieved by establishing a low water activity of 0.6 or less. In addition, the cheesecake filling composition can include various ingredients representing sources of fiber used to establish a cheesecake snack product having a significant percentage of the recommended daily value of fiber.

In particular, the invention is directed to creating a cheesecake filling formulated utilizing real cream cheese, but preferably without the use of preservatives. The cheesecake filling can be used to make various products, including a cheesecake snack bar including a crust or base, such as a graham-type crumb base, upon which the cheesecake filling is applied. The base and cheesecake filling can be separately formed or shaped, and then baked. In one form of the invention, the combined base and cheesecake filling are cut into bars which are separately packaged for sale in non-refrigerated shelves of food stores.

Additional objects, features and advantages of the invention will become more readily apparent from the following detailed description when taken in conjunction with the drawings wherein like reference numerals refer to corresponding parts in the several views.

### BRIEF DESCRIPTION OF THE DRAWINGS

FIG. 1 is a perspective view of a snack bar, incorporating a cheesecake filling in accordance with the invention, partially withdrawn from a package.

### DETAILED DESCRIPTION OF INVENTION

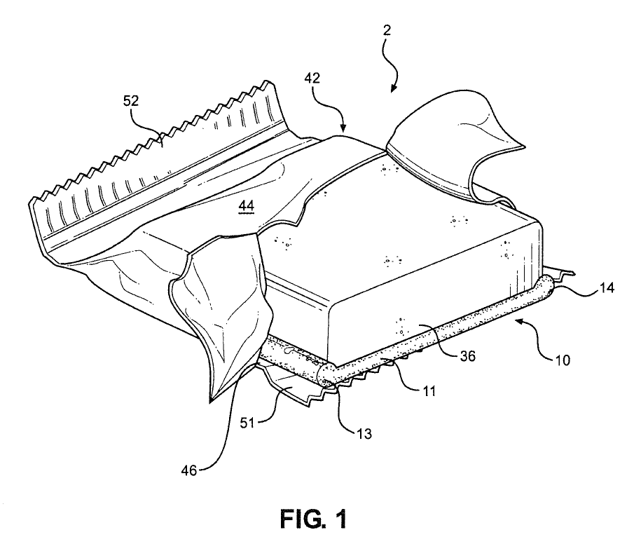

With reference to FIG. 1, a packaged food bar 2 is shown to include a base 10 having a bottom portion 11 leading to upstanding side portions 13 and 14. Arranged upon bottom portion 11 is a filling material 36, particularly a non-flowable, extruded or otherwise shaped cheesecake filling 36 specifically formulated in accordance with the invention to exhibit an extensive, shelf stable life as will be detailed fully below. As depicted in this FIGURE, food bar 2 is intended to be wrapped in a package 42 including a top layer 44 and a bottom layer 46, with top layer 44 and bottom layer 46 being sealed together along end seals 51 (shown opened in FIG. 1) and 52.

By managing water activity, it has been found that the desired, extensive shelf life (meaning a shelf stable life in the order of 8 months without refrigeration) in accordance with the invention can be achieved for cheesecake filling 36. More specifically, it is important that the cheesecake filling 36 exhibit a water activity of less than 0.6. At the same time, it is considered important that cheesecake filling 36 retain textural and sensory properties of an indulgent cheesecake. In accordance with other aspects of the invention, it is desired to have cheesecake filling 36 represent an excellent source of fiber, preferably about 20% of the recommended daily value of fiber, i.e., approximately five (5) grams of fiber.

In achieving these objects, cheesecake filling 36 includes a cream-based body employing, at least in part, real cream cheese which is firm and non-flowable. In particular, cheesecake filling 36 is constituted by a mixture of the firm and non-flowable real cream cheese (preferably between 15-30% by weight and, more preferably, between 20-25%), and dried dairy powders including, but not limited to, cream cheese, sour cream, nonfat milk and buttermilk powders. Further additives include a water binder, one or more sweeteners, texturing agents, gelling agents, leaveners and flavorings. Furthermore, a source of fiber is preferably added, as well as a protein containing flour.

Although there are many known ingredients which can satisfy the additives listing set forth below, in preferred embodiments: glycerine is used as a water binder; both fructose and granulated sugar are employed as sweeteners; shortening and dried egg white are employed as texturing agents; pregelatinized starch has been found to be a good gelling agent; sodium bicarbonate (baking powder or baking soda), along with cream of tartar is the preferred leavening system; and salt, artificial vanilla powder, lactic acid, citric acid, and natural and artificial flavorings function to flavor the cheesecake filling 36. In addition, when looking to provide an enhanced fiber content as well, various sources of fiber can be utilized, such as soluble corn fiber. A general, desired range of fiber is between 6.4-22.4% by weight, while a more preferred range would have a low of 9.6% by weight. Finally, a suitable protein containing flour is wheat or red winter flour.

By way of a specific example, a non-flowable cheesecake filling 36 which is thick, i.e., has a non-flowable, modeling clay or Playdough-like consistency (as opposed to a typical cheesecake filling which takes the form of a runny batter which will not hold its shape), an extensive shelf stable life and a high fiber content in accordance with the invention has been formulated as follows:

| Filling Ingredients | % by Weight |
|---|---|
| Real Cream Cheese | 24.885 |
| Soluble Corn Fiber | 21.90 |
| Glycerine | 11.31 |
| Dried Dairy Powders | 8.91 |
| Fructose | 8.27 |
| Shortening | 5.00 |
| Corn Starch | 4.25 |
| Sour Cream Powder | 3.71 |
| Dried Egg White | 3.51 |
| Granulated Sugar | 3.10 |
| Wheat Flour | 3.08 |
| Cream of Tartar | 0.93 |
| Flavoring | 0.43 |
| Sodium Bicarbonate | 0.42 |
| Vanilla | 0.13 |
| Salt | 0.10 |
| Lactic Acid Powder | 0.04 |
| Citric Acid | 0.025 |

Obviously, cheesecake filling 36 can be utilized for various purposes. However, a preferred use is in connection with food bar 2 having base 10 established by a graham-type crust. For the sake of completeness, an exemplary base 10 was prepared with the following ingredients:

| Crust Ingredients | % by Weight |
|---|---|
| Wheat Flour | 22.55 |
| Whole Wheat Flour | 22.55 |
| Brown Sugar | 17.15 |
| Butter | 15.83 |
| Soluble Corn Fiber | 7.60 |
| Water | 4.50 |
| Honey | 3.57 |
| Refiner's Syrup | 3.57 |
| Glycerine | 2.11 |
| Salt | 0.50 |
| Flavoring | 0.07 |

When the cheesecake filling 36 is employed to make food bar 2, the actual size of each food bar 2 can vary in accordance with the invention. However, a preferred embodiment provides for: an overall width in the order of 2-3 inches (approximately 5-7.5 cm); an overall height in the order of ½ to ¾ inches (approximately 1.25-2 cm); and a height or thickness for bottom portion 11 in the order of ⅛ inches (approximately 3 mm). In addition, the length of each bar 2 can vary, but is preferably at least as long as the overall width. In any case, it should be understood that these disclosed and illustrated embodiments are illustrative and not restrictive.

Based on the above, it should be readily apparent that the invention provides for a cheesecake filling which can be used in making various products, including snack bars, wherein the filling will be shelf stable for an extensive time period, without refrigeration. Even with the use of the real cream cheese-based ingredients outlined above, it has been surprising found that the need for preservatives can be avoided in accordance with the invention while still achieving the extensive shelf stable life at a storage temperature above refrigerated conditions for the product. Again, it is particularly important in achieving this goal to assure that the water activity of the cheesecake filling be establish as less than 0.6. In any case, the filling can also be advantageously formulated to provide a significant source of fiber and/or protein. Additional fiber can also be added to the base or crust, such as more soluble corn fiber, e.g., 8% by weight. In any case, although disclosed with reference to preferred embodiments of the invention, it should be readily apparent that various changes and modifications can be made to the invention without departing from the spirit thereof. For instance, other bases could be employed, such as a chocolate or brownie base. In addition, various toppings could be added, such as a fruit or caramel stripe extending along a top portion of the snack bar, frosting, a glaze, sprinkles or the like.

1. A snack bar comprising:
a base establishing a crust; and
a cheesecake filling provided on the crust, said cheesecake filling having a water activity of less than 0.6, wherein said snack product has an extensive shelf stable life, without refrigeration.

2. The snack bar of claim 1, wherein the crust defines a graham cracker or chocolate base for the snack bar.

3. The snack bar of claim 2, wherein the base includes opposing upstanding side portions between which the cheesecake filling is contained.

4. The snack bar of claim 1, wherein the cheesecake filling includes real cream cheese which is firm and non-flowable.

5. The snack bar of claim 4, wherein the real cream cheese constitutes between 15-30% by weight of the cheesecake filling.

6. The snack bar of claim 5, wherein the real cream cheese constitutes between 20-25% by weight of the cheesecake filling.

7. The snack bar of claim 4, wherein the cheesecake filling further includes dried dairy powders.

8. The snack bar of claim 4, wherein the cheesecake filling further includes a water binder, one or more sweeteners, at least one texturing agent, at least one gelling agent, a leavening system and flavorings.

9. The snack bar of claim 4, wherein the cheesecake filling lacks a preservative.

10. The snack bar of claim 4, wherein the cheesecake filling further includes a source of fiber, with the snack bar including approximately 5 grams of fiber.

11. The snack bar of claim 1, wherein the snack bar has an overall length and an overall width, each being in the order of 2-3 inches (approximately 5-7.5 cm).

12. A cheesecake filling having a water activity of less than 0.6 and an extensive shelf stable life, without refrigeration.

13. The cheesecake filling of claim 12, wherein the cheesecake filling includes real cream cheese which is firm and non-flowable.

14. The cheesecake filling of claim 13, wherein the real cream cheese constitutes between 15-30% by weight of the cheesecake filling.

15. The cheesecake filling of claim 14, wherein the real cream cheese constitutes between 20-25% by weight of the cheesecake filling.

16. The cheesecake filling of claim 13, wherein the cheesecake filling further includes dried dairy powders.

17. The cheesecake filling of claim 13, wherein the cheesecake filling further includes a water binder, one or more sweeteners, at least one texturing agent, at least one gelling agent, a leavening system and flavorings.

18. The cheesecake filling of claim 13, wherein the cheesecake filling lacks a preservative.

19. The cheesecake filling of claim 13, wherein the cheesecake filling further includes between 6.4-22.4% by weight of fiber.

20. A method of making snack bars comprising:
providing a base; and
providing a cheesecake filling upon the base, with the cheesecake filling having a water activity of less than 0.6 and an extensive shelf stable life, without refrigeration.

21. The method of claim 20, wherein the cheesecake filling is made with real cream cheese which is firm and non-flowable.

22. The method of claim 21, wherein the cheesecake filling is made without preservatives.

23. The method of claim 21, wherein the real cream cheese constitutes between 15-30% by weight of the cheesecake filling.

24. The method of claim 23, wherein the real cream cheese constitutes between 20-25% by weight of the cheesecake filling.

25. The method of claim 21, wherein the cheesecake filling further includes dried dairy powders.

26. The method of claim 21, wherein the cheesecake filling further includes a water binder, one or more sweeteners, at least one texturing agent, at least one gelling agent, a leavener and flavorings.

27. The method of claim 21, wherein the cheesecake filling further includes a source of fiber, with each snack bar, from the cheesecake filling alone, including between 6.4-22.4% by weight of fiber.

28. The method of claim 20, further comprising: cutting the base into individual snack bars each having overall length and width dimensions in the order of 2-3 inches (approximately 5-7.5 cm).
